(19) United States
(12) Patent Application Publication
(10) Pub. No.: US 2026/0314857 A1
(43) Pub. Date: Oct. 15, 2026

(54) CUPHOLDER INSERT

(71) Applicant: JEFFERY BARON LESPERANCE, HOWELL, MI (US)

(72) Inventor: JEFFERY BARON LESPERANCE, HOWELL, MI (US)

(21) Appl. No.: 19/641,216

(22) Filed: Apr. 7, 2026

Related U.S. Application Data
(60) Provisional application No. 63/785,801, filed on Apr. 9, 2025.

(51) Int. Cl. A47G 23/02; F16M 13/02

(52) U.S. Cl. CPC A47G 23/0225; F16M 13/022

(57) ABSTRACT

A cupholder insert is configured to be removably coupled to a host object, such as luggage, a cooler, a chair, a stroller, a cart, or another support structure. The insert includes a housing defining an interior receptacle, an upper rim, a bottom wall, and a coupling assembly configured to engage a receiving feature of the host object. The housing may taper, and the interior receptacle may include resilient retention members or interchangeable rings for accommodating beverage containers of different sizes. The coupling assembly may include a deformable fastener, a threaded mount, a friction fit, a snap fit, a magnetic mount, a suction mount, a strap, or a clamp. Optional features include insulated walls, drainage openings, a mounting dock, collapsible wall structures, lights, and sensors.

### CROSS REFERENCE TO RELATED APPLICATIONS

This application claims priority to U.S. Provisional Patent Application No. 63/785,801, filed Apr. 9, 2026, the entire disclosure of which is incorporated herein by reference.

### FIELD OF DISCLOSURE

The present disclosure relates generally to beverage holders and, more particularly, to a cupholder insert configured to be coupled to a host object, such as luggage, furniture, carts, strollers, coolers, vehicle interior components, and similar structures, so that a beverage container can be supported in a stable and accessible manner.

### BACKGROUND

Cupholders are widely used in vehicles, seating products, outdoor equipment, and other consumer goods because users frequently carry beverages while simultaneously performing other tasks. A stable receptacle for a beverage container reduces spills, frees a user's hands, and improves convenience.

Despite the prevalence of cupholders in many consumer products, luggage and other portable host objects frequently lack a dedicated location for holding a beverage container. Travelers commonly move through airports, stations, parking areas, and similar environments while simultaneously handling rolling luggage, tickets, personal devices, and beverages. When a host object does not include a reliable beverage holder, the user may be forced to balance a drink on top of the object, carry the drink by hand, or temporarily set the drink on an unrelated surface, each of which increases the risk of spills, drops, or forgotten containers.

Comparable shortcomings also exist outside the travel context. Coolers, folding chairs, strollers, carts, walkers, wheelchairs, railings, and other portable or temporary-use structures often present no convenient place to support a beverage container. Existing add-on holders can be bulky, insecure, visually unappealing, or poorly adapted to different host-object constructions and different beverage-container sizes.

Accordingly, there remains a need for a cupholder insert that can be securely mounted to or within a wide variety of host objects, that can be removable or semi-permanent depending on the application, and that can accommodate beverage containers of different sizes and shapes while maintaining stability during ordinary use and movement.

### SUMMARY

In one aspect, the disclosure provides a cupholder insert configured to be removably coupled to a host object. The cupholder insert can include a housing defining an interior receptacle sized to receive a beverage container, an upper rim, a bottom wall opposite the upper rim, and a coupling assembly carried by the housing. The coupling assembly can engage a receiving feature of the host object so that the cupholder insert is retained relative to the host object during use.

In various embodiments, the housing can taper from a larger cross-sectional dimension adjacent the rim to a smaller cross-sectional dimension adjacent the bottom wall. The rim can include an outward flange configured to overlie an exterior surface of the host object and to limit insertion depth. The interior receptacle can include one or more resilient retention members, liners, sleeves, rings, or similar engagement structures configured to contact beverage containers of different diameters.

In another aspect, the disclosure provides an assembly including the cupholder insert and a host object. The host object can include an opening, cavity, receiving opening, rail, handle, frame member, threaded receptacle, magnetically attractive structure, docking structure, or other mounting feature configured to cooperate with the cupholder insert. The host object can be luggage, a cooler, a chair, a stroller, a cart, a wheelchair, a walker, camping equipment, a vehicle interior component, or another structure for which beverage-container support is desired.

In still another aspect, the disclosure provides methods for retrofitting a host object with a beverage holder by positioning the cupholder insert adjacent a receiving portion of the host object, engaging the coupling assembly with the receiving portion, and placing a beverage container in the cupholder insert. The engagement may be achieved by a deformable fastener, a threaded engagement, a friction fit, a snap fit, a magnetic attachment, a suction attachment, a clamp, a strap, a docking assembly, or any combination thereof.

Optional features can include collapsible or telescoping housing structures, insulated walls, drainage openings, interchangeable insert rings, lights, sensors, indicators, heating elements, decorative sleeves, branded components, and mounting docks that can tilt or swivel relative to the host object. The foregoing summary is provided to introduce examples discussed below and is not intended to define or limit the scope of the claims.

In one aspect, the present disclosure provides a cupholder insert configured to be removably coupled to a host object. The cupholder insert can include a housing defining an interior receptacle sized to receive a beverage container, an upper rim, a bottom wall opposite the upper rim, and a coupling assembly carried by the housing and configured to engage a receiving feature of the host object to retain the cupholder insert relative to the host object during use. In various embodiments, the housing can taper from a larger cross-sectional dimension adjacent the upper rim to a smaller cross-sectional dimension adjacent the bottom wall, and the upper rim can include an outward flange configured to overlie an exterior surface of the host object.

In certain embodiments of the cupholder insert, the interior receptacle can include one or more resilient retention members configured to engage beverage containers of different sizes. The coupling assembly can include a deformable shaft and enlarged head configured to pass through an opening in the host object and resist withdrawal, or can additionally or alternatively include at least one of a threaded mount, magnetic mount, suction mount, snap-fit mount, friction-fit mount, strap assembly, or clamp assembly. In further embodiments, the housing can be movable between an expanded use position and a collapsed storage position, such as by telescoping sections, hinged sidewalls, or an accordion wall structure.

In another aspect, the present disclosure provides a beverage-holder assembly including a host object and the cupholder insert coupled thereto. The host object can include at least one of an opening and a mounting structure configured to cooperate with the coupling assembly. By way of example, the host object can comprise luggage, a cooler, a chair, a stroller, a cart, a wheelchair, a walker, camping equipment, or a vehicle interior component. In some embodiments, the cupholder insert is detachably received in an opening of the host object so that the upper rim limits movement of the insert through the opening. In additional embodiments, the assembly can include a mounting dock configured to tilt or swivel the insert relative to the host object, a clamp configured to secure the insert to a rail, handle, or frame member, and/or one or more interchangeable rings selectively positionable within the interior receptacle to adapt the insert to beverage containers of different sizes.

In still another aspect, the present disclosure provides a method of providing a beverage holder to a host object. The method can include positioning a cupholder insert adjacent a receiving portion of the host object, engaging a coupling assembly carried by the cupholder insert with the receiving portion of the host object to secure the cupholder insert relative to the host object, and placing a beverage container in the interior receptacle of the cupholder insert. In various embodiments, engaging the coupling assembly can include inserting a deformable fastener through an opening in the host object or clamping the cupholder insert to a rail, handle, or frame member of the host object. The method can further include selecting and installing an interchangeable ring, causing one or more resilient retention members to flex into engagement with the beverage container, and permitting liquid to pass through one or more drainage openings formed in a lower portion of the cupholder insert.

### BRIEF DESCRIPTION OF THE DRAWINGS

The accompanying drawings illustrate representative embodiments of the disclosed cupholder insert and related assemblies and methods of use. The drawings are provided to facilitate an understanding of exemplary structures, mounting arrangements, and optional features of the disclosure, and are not intended to limit the scope of the claimed subject matter.

FIG. 1 is a top-side perspective view of a cupholder insert according to an embodiment of the present disclosure.

FIG. 2 is a bottom-side perspective view of the cupholder insert of FIG. 1.

FIG. 3 is a bottom plan view of the cupholder insert of FIG. 1.

FIG. 4 is a top-side perspective view of an embodiment of the cupholder insert including inwardly extending retention members.

FIG. 5 is a bottom-side perspective view of an embodiment of the cupholder insert including a deformable coupling assembly.

FIG. 6 is a top plan view of the embodiment shown in FIG. 4.

FIG. 7 is a sectional side view of a cupholder insert.

FIG. 8 is an exploded perspective view of a cupholder insert and a piece of luggage having a receiving opening configured to receive the cupholder insert.

FIG. 9 is a perspective view of a cupholder insert mounted in a cooler.

FIG. 10 is an exploded perspective view, partially in section, of a cupholder insert and a piece of luggage.

FIG. 11 is a bottom-side perspective view of an alternate embodiment of a cupholder insert including a deformable fastener.

FIG. 12 is a sectional perspective view of a cupholder insert having an insulated wall and drainage openings.

FIG. 13 is a perspective view of a cupholder insert including one or more retention members, a light source, and a sensor.

FIG. 14 is a perspective view of a cupholder insert mounted to a stroller or similar frame by a mounting dock.

FIG. 15 is an exploded perspective view of interchangeable rings configured for use with a cupholder insert.

FIG. 16 is a perspective view of a chair or similar host object incorporating a cupholder insert.

FIG. 17 is a perspective view of an alternative cupholder insert including inwardly extending retention members.

FIG. 18 is a bottom plan view of a cupholder insert including a coupling assembly.

FIG. 19 is a perspective view of a cupholder insert coupled to a railing or frame member by a clamp assembly.

Like reference numerals are used in the drawings to identify like or corresponding components throughout the several views. The illustrated embodiments are exemplary only, and it should be understood that features shown in one figure or embodiment may be used with other figures or embodiments where appropriate.

### DETAILED DESCRIPTION

The following detailed description refers to the accompanying drawings and describes exemplary embodiments of the disclosed cupholder insert, related host-object assemblies, and methods of installation and use. The description is intended to illustrate, and not to limit, the claimed subject matter. Unless the context clearly requires otherwise, directional and positional terms such as upper, lower, inward, outward, top, bottom, and side are used with reference to the orientations shown in the drawings for convenience of description and do not require any particular orientation in manufacture, storage, transport, or use.

The present disclosure is directed to a cupholder insert 10 that can be mounted to, supported by, suspended from, or otherwise coupled relative to a host object so that a beverage container is maintained in a secure and accessible position. For clarity, certain terminology is used consistently throughout this specification, although the disclosed subject matter is not limited by the particular labels selected. As used herein, the term ‘cupholder insert’ broadly refers to a receptacle-defining component that can itself be received in an opening or cavity, can cooperate with a separate mounting dock, or can otherwise be attached to a host object in a way that enables the receptacle to function as a beverage holder. The term therefore is not restricted to embodiments in which the insert is fully seated within an aperture. The term ‘host object’ refers broadly to any article, assembly, fixture, structural member, vehicle component, furniture component, travel product, or accessory with which the cupholder insert is associated. The term ‘beverage container’ includes, by way of example, a can, bottle, cup, tumbler, mug, travel mug, disposable beverage cup, baby bottle, sports bottle, thermally insulated vessel, or similar item. In some implementations, the insert may also temporarily receive another article of generally similar size or shape, such as a snack container, small tool, phone, keys, or personal item, although beverage-container retention remains a principal use. The term ‘coupling assembly’ refers broadly to one or more structures that directly or indirectly retain the cupholder insert relative to the host object. The term ‘receiving feature’ refers broadly to any opening, recess, track, boss, threaded structure, rail, frame member, magnetically attractive region, surface, or other portion of the host object that cooperates with the coupling assembly.

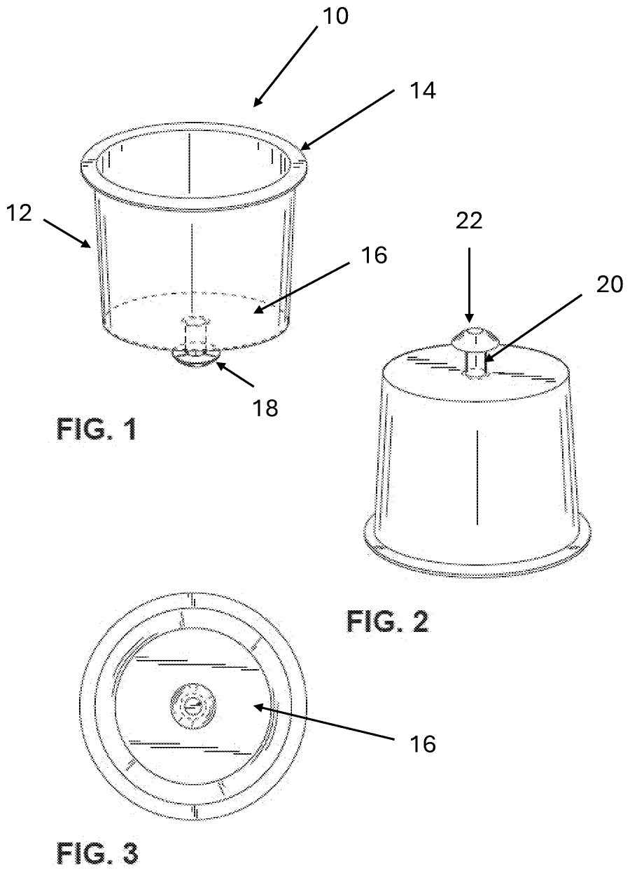

Referring initially to FIGS. 1-3, a representative cupholder insert 10 can include a housing 12, an upper rim 14, and a bottom wall 16 that together define an interior receptacle for receiving a beverage container. In the illustrated embodiment, the housing 12 has a generally frustoconical or tapered configuration, with the upper region adjacent the rim 14 having a greater cross-sectional dimension than the lower region adjacent the bottom wall 16. A tapered relationship of this type can facilitate nesting of multiple inserts during shipping, can promote easier insertion of the insert into a corresponding opening in a host object, and can improve compatibility with tapered disposable cups and certain bottles. The housing 12, however, need not taper uniformly or continuously. In other embodiments, the housing can include one or more cylindrical portions, stepped portions, curved or compound-taper portions, or localized relief regions for accommodating particular beverage-container shapes. The interior receptacle can extend substantially the full height of the insert, or can be interrupted by ledges, shoulders, protrusions, or removable inserts that locally modify the available receiving volume.

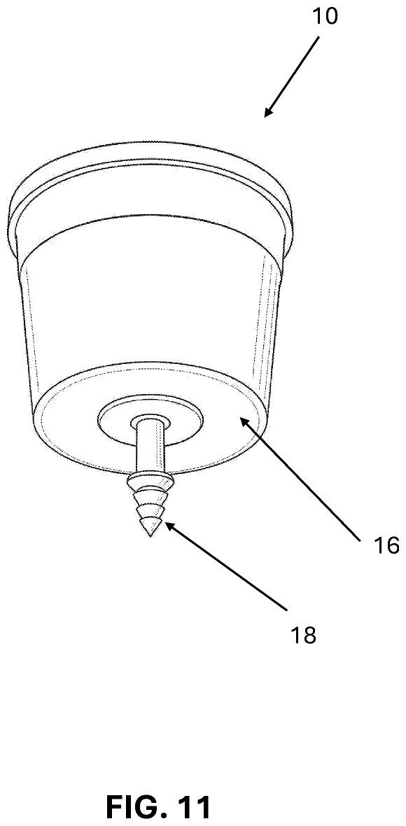

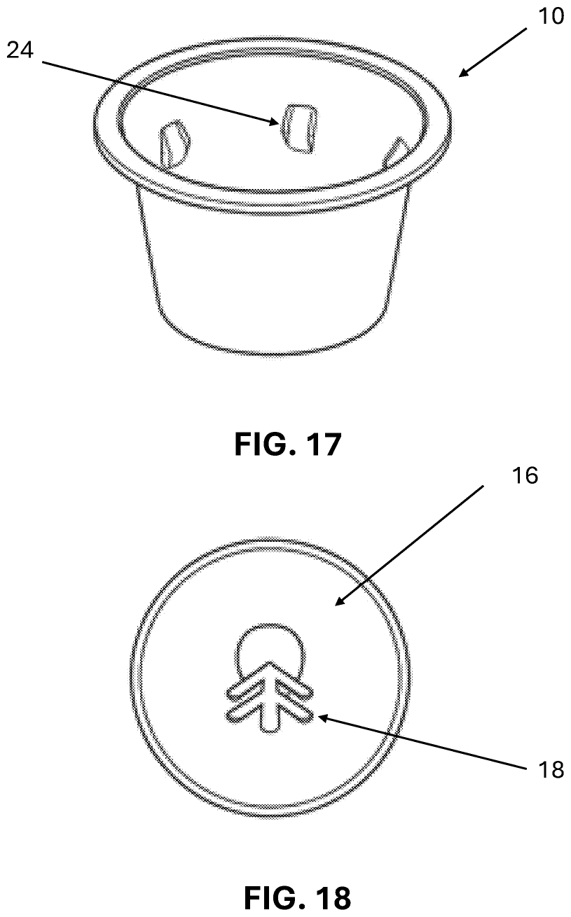

The housing 12 can assume a wide range of plan-view shapes and is not limited to the generally circular embodiments shown in FIGS. 1-19. By way of example, the housing can be circular, elliptical, oval, obround, rounded-rectangular, rounded-square, polygonal, D-shaped, asymmetrical, or hybrid in plan. Corners may be sharp, chamfered, filleted, or elastomerically cushioned. The wall thickness may be constant or may vary by height, azimuthal location, or function. In some embodiments, thicker wall regions can be used where greater stiffness is desired, such as adjacent the rim, adjacent a coupling location, or adjacent a clamp or dock interface. In other embodiments, thinner or more compliant wall regions can be used to promote elastic deflection, facilitate collapse, or provide impact absorption. The housing can be formed as a single, unitary component, or as a multi-piece assembly comprising an outer shell and one or more inner liners, sleeves, jackets, insulating structures, reinforcement rings, or trim components.

The upper rim 14 can define a reinforced border of the housing 12 and can perform several functions beyond simply defining the open upper end of the receptacle. In many embodiments, the rim 14 includes an outwardly extending flange, lip, bead, collar, or rolled edge configured to overlie an exterior surface of the host object when the insert is installed in an opening. Such a structure can limit insertion depth, distribute downward loading over a larger area, reduce stress concentration at the host-object opening, and improve perceived finish quality. The upper rim can also serve as a handling feature that permits the user to grasp and remove the insert from the host object. The underside of the rim may be flat, stepped, tapered, curved, gasketed, or textured. In some embodiments, the underside can carry an elastomeric sealing ring, compressible gasket, friction-enhancing pad, or anti-rattle coating that reduces vibration between the insert and the host object. In some implementations, the rim can include keying structures such as flats, tabs, notches, splines, or protrusions that cooperate with complementary structures of the host object to discourage rotation. The rim also may include cutouts, straw notches, handle-clearance regions, drainage-relief notches, or lid-engagement features. Decorative or branded trim rings can be secured to the rim for visual customization without altering the primary structural insert.

The bottom wall 16 can provide support for the lower end of a received beverage container and can also function as a structural interface for the coupling assembly 18. The bottom wall may be planar, concave, convex, stepped, recessed, domed, ribbed, vented, perforated, or otherwise contoured. In some embodiments, the bottom wall can include a central support surface sized to contact a base portion of a beverage container, while surrounding recesses, channels, or valleys permit drainage or collect incidental condensation. In other embodiments, the bottom wall can include a resilient puck, pad, spring element, or compliant insert that cushions the beverage container, reduces noise, or increases friction. The bottom wall can be formed integrally with the sidewall of the housing, can be attached as a separate closure member, or can define only a partial lower support so that part of the beverage container extends below the nominal lower edge of the housing. In yet other embodiments, the bottom region of the insert can include removable caps, plugs, trays, screens, or sediment-collecting features that facilitate cleaning or allow the same insert body to be configured either for dry indoor use or for wet outdoor use.

The cupholder insert 10 can be produced from a wide variety of materials selected according to the intended environment, cost target, weight target, cleaning requirements, and desired feel. Suitable materials include, without limitation, polypropylene, polyethylene, ABS, polycarbonate, nylon, acetal, PET, PVC, thermoplastic elastomers, silicone, rubber-like materials, natural or synthetic fiber-reinforced composites, carbon-filled polymers, biodegradable polymers, cellulose-based composites, metals such as aluminum or stainless steel, wood or bamboo composites, and combinations of the foregoing. A rigid outer shell can be combined with a softer liner, a thermally insulating middle layer, a weighted base, or an overmolded rim. The selected material or material combination may be food-safe, dishwasher-safe, UV-resistant, impact-resistant, chemically resistant, stain-resistant, or temperature-resistant depending on the use case. Manufacturing techniques can include injection molding, compression molding, blow molding, thermoforming, extrusion, machining, stamping, casting, additive manufacturing, overmolding, insert molding, welding, fastening, or adhesive assembly. In some manufacturing approaches, multiple inserts can be nested or stacked to reduce shipping volume, and the rim geometry can be selected to facilitate automated packaging or downstream assembly into a host object.

The coupling assembly 18 can be carried by the housing 12 in a centered arrangement, an offset arrangement, or a plural arrangement, and it can be formed integrally with the housing, secured to the housing as a separate element, or coupled through an intermediary dock or plate. In the representative embodiments of FIGS. 1, 2, 5, 7, 10, 11, and 18, the coupling assembly 18 projects generally downward from the bottom wall 16. This configuration is advantageous where the host object presents an opening or aperture in an upper surface, such as the top wall of luggage or a cooler lid. However, the disclosure is not limited to bottom-mounted coupling. In other embodiments, the coupling assembly may be carried by the sidewall of the housing, by the rim, by an external bracket attached to the housing, or by a separate docking component that receives the insert. The coupling assembly can be releasable, semi-permanent, or permanent. It can be sized for a single-use installation, repeated installation and removal, or selective interchange among multiple host objects. In some embodiments, the coupling assembly can itself be modular so that a user can remove one mounting structure and attach another mounting structure better suited for a different host-object type.

As further shown in FIGS. 1, 2, 5, 7, 10, 11, and 18, one presently contemplated form of the coupling assembly 18 comprises a deformable fastener including a shaft 20 and an enlarged head 22 or equivalent retaining region. The shaft 20 can be cylindrical, tapered, stepped, fluted, ribbed, hollow, solid, slotted, or otherwise shaped. The enlarged head 22 can be rounded, conical, barbed, finned, tree-like, arrow-like, mushroom-shaped, split, segmented, or otherwise configured to pass through an opening in the host object during insertion and then resist withdrawal after insertion. The deformable fastener can be formed of the same material as the housing or of a different material selected to provide a different degree of flexibility, resilience, or wear resistance. For example, a relatively rigid housing can be paired with a more compliant elastomeric or semi-rigid retention fastener. One or more retaining shoulders, annular ribs, barbs, compressible fins, or undercut surfaces can cooperate with the host-object opening to resist pullout. In some embodiments, the deformable fastener can be installed from above through a through-hole in the host object and can snap into a retained position. In other embodiments, the fastener can be inserted into a grommet, bushing, sleeve, or reinforcing collar positioned within the opening. The fastener may include a stop shoulder that limits insertion depth, a keyed profile that discourages rotation, or a releasable latch feature that allows intentional removal when desired.

The coupling assembly 18 is not limited to a deformable fastener and can instead or additionally include substantially any mounting architecture capable of supporting the insert relative to a host object. Illustrative alternatives include threaded studs, threaded sockets, threaded rings, nut-and-bolt assemblies, bayonet connectors, quarter-turn locks, snap-fit interfaces, living-hinge clamps, friction-fit ribs, elastomeric plugs, magnetic members, ferromagnetic targets, suction cups, pressure-sensitive adhesive pads, hook-and-loop structures, straps, buckles, cinch cords, cable ties, hook structures, latches, brackets, rails, dovetails, slide-in cartridges, spring clips, over-center locks, toggle anchors, expanding anchors, removable pins, cotter arrangements, and keyed docking members. A single insert can include multiple coupling structures simultaneously. For example, a cupholder insert may include a bottom-mounted plug for insertion into an opening and also an outer gasket or side ribs for supplemental frictional stabilization. Likewise, a clamp-mounted embodiment can include both a clamping structure and a secondary tether or safety strap. In some implementations, multiple alternative coupling assemblies can be packaged with the insert so that the same receptacle body can be mounted in an aperture of luggage, clamped to a stroller frame, or docked to another support structure without replacing the receptacle itself.

In some embodiments, the coupling assembly 18 can cooperate with a host-object receiving feature at more than one location to improve stability or control orientation. A first interaction region may provide primary vertical retention while a second interaction region prevents rotation, dampens vibration, establishes an angular index, or limits tilting of the insert. By way of example, the lower portion of the housing can include external flats, keys, ribs, knurls, protrusions, or compression zones that engage corresponding surfaces of an aperture or cavity. The rim 14 can likewise include anti-rotation tabs or a keyed profile that seat against the host object. A separate retaining ring, plate, bezel, or backing member can be positioned on an opposite side of the host-object wall. In certain implementations, the insert may be captured between upper and lower plates or collars. In other implementations, the insert may be suspended from a rail or frame member by a dock that itself provides multiple points of contact. This multi-point concept can be used whether the host object is a relatively rigid hard shell, a fabric-covered frame, a tubular rail, or another structure.

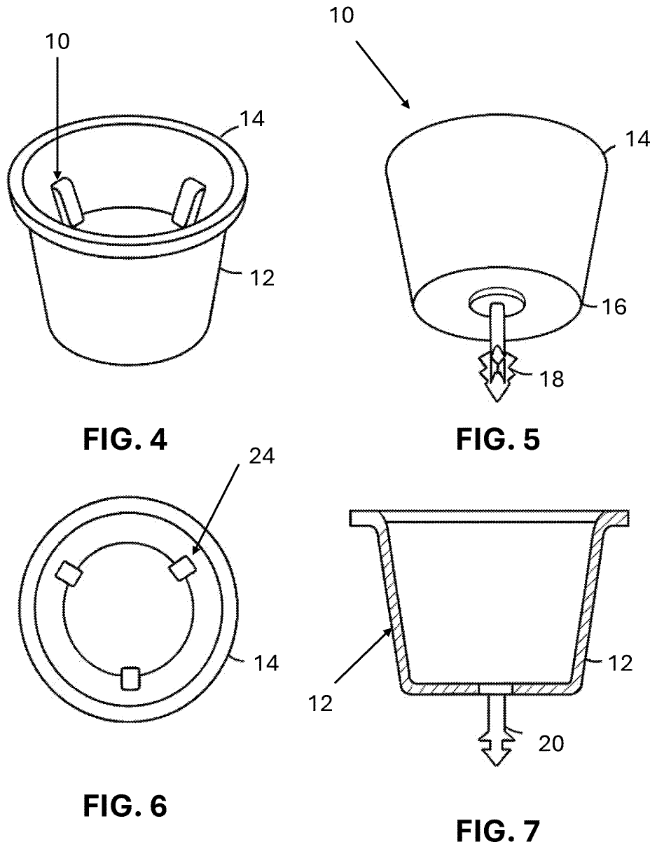

FIGS. 4, 6, and 17 illustrate embodiments in which the interior receptacle includes one or more retention members 24 extending inwardly from the housing 12. The retention members 24 can be formed as resilient tabs, cantilevered fingers, ribs, lugs, bumps, pads, vanes, leaf springs, fins, petals, segmented rings, deformable diaphragms, foamed projections, molded elastomeric bodies, or separate inserts carried by the housing. The number of retention members can be one, two, three, four, five, six, or more. The retention members can be equally spaced, unequally spaced, vertically aligned, helically arranged, or grouped to favor a particular container profile. For example, retention members may be positioned at one height to engage a substantially cylindrical beverage can and at another height to engage a tapered cup. The retention members can be relatively rigid and rely primarily on geometric interference, or they can be highly compliant so that they deform to accommodate a broad range of container diameters. In some embodiments, the retention members can be individually replaceable or can be selected from a set of inserts having different stiffness or geometry.

The beverage-container engagement structures located within the receptacle are not restricted to the particular tab-like retention members shown in the drawings. In other embodiments, the cupholder insert can include a continuous or discontinuous internal liner, a split sleeve, a removable elastomeric boot, an iris-like adapter, one or more concentric rings, a spring-biased basket, a net-like support structure, a compressible annular band, or a set of stacked size-reduction rings. Such structures can reduce wobble, increase frictional engagement, protect delicate drinkware, and permit the same insert body to receive containers ranging from relatively small bottles to larger tumblers. In some variants, the upper interior region of the housing can include a lead-in chamfer, funnel region, or guide surface that centers a beverage container during insertion. In some embodiments, the interior receptacle can include one or more slots or reliefs that accommodate a protruding feature of the beverage container, such as a bottle shoulder, straw, flip-top lid tab, or mug handle. A user therefore can configure the insert for both common beverage forms and niche container geometries without requiring a completely different outer insert body.

The interior and lower regions of the receptacle can also be configured to manage load distribution, fluid management, and user experience. A bottom-support pad can be textured to resist sliding of a container base. A raised central boss or annular seat can support a container base above a surrounding collection region so that condensation or spilled liquid does not continuously contact the base of the container. One or more channels can guide liquid toward drainage openings or toward a removable collection area. Friction-enhancing textures, soft-touch coatings, flocked surfaces, and noise-damping layers can reduce rattling and improve feel. In some embodiments, the lower region of the insert can include a weighted element that lowers the center of gravity and makes the insert feel more substantial, especially where the insert is removably mounted to a lightweight host object. In other embodiments, the lower region can be intentionally lightweight to minimize added mass for travel applications. The interior surface can also include measurement marks, fill-indicator marks, decorative textures, logos, or other visible indicia.

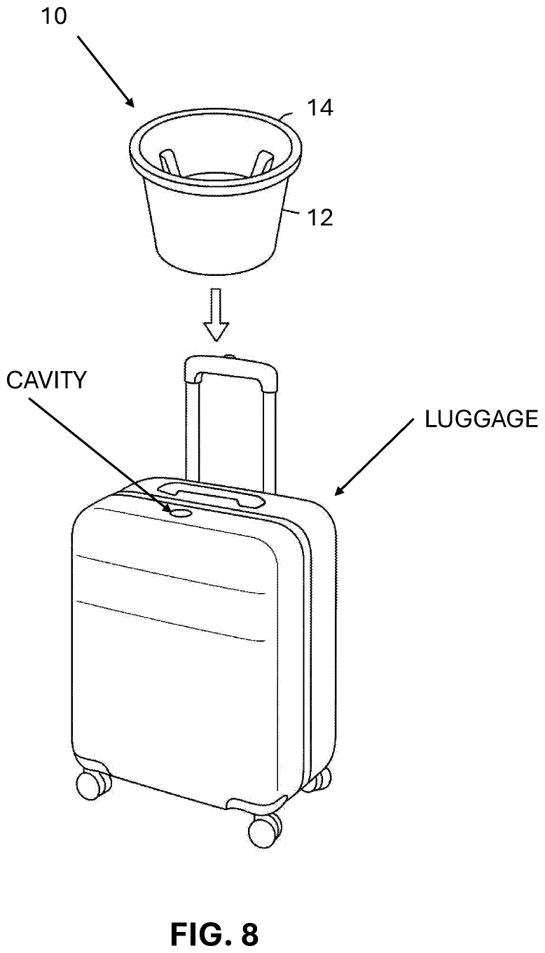

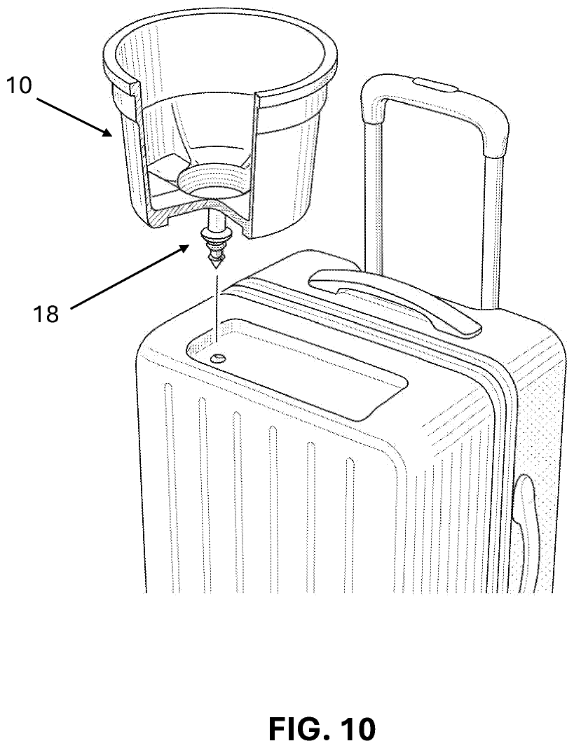

FIGS. 8 and 10 illustrate representative luggage-related implementations. As shown in FIG. 8, the host object may be an article of rolling luggage including a receiving opening or cavity positioned in a top wall or other accessible region. The opening can be formed directly through a hard-shell panel, through a reinforcing bezel secured to a panel, through a frame member concealed beneath fabric, or through an accessory plate mounted to the luggage. The opening may extend completely through a wall of the luggage or may communicate with an underlying blind recess, pocket, or well. The insert can be installed during original manufacture, at a customization stage, or after sale as part of a retrofit kit. In a hard-shell luggage embodiment, the host-object wall can itself provide adequate structural support for the insert, while in a soft-sided luggage embodiment the opening can be reinforced by a grommet, ring, washer, plate, backing member, molded reinforcement, or internal frame feature. The insert may be located adjacent a handle recess, near a telescoping handle support, on a side wall, near an exterior pocket, or at another position selected for access and balance. A single luggage article can include more than one receiving feature so that the insert can be placed in different positions or so that multiple inserts can be used simultaneously.

FIG. 10 shows an exploded, partially sectioned luggage embodiment that illustrates how the insert can interact with a host-object opening and coupling feature. In some implementations, the lower portion of the housing 12 extends through the host-object opening while the rim 14 remains above the host-object surface. The coupling assembly 18 then passes into or through a corresponding aperture, grommet, or receiver to retain the insert. The partially sectioned perspective also suggests that the lower region of the housing can be shaped to clear internal structures of the host object, such as reinforcement ribs, frame components, liners, zippers, handle wells, or stored items. Where interior clearance is limited, the lower portion of the insert can be shortened, offset, laterally relieved, or locally flattened. Reinforcement components such as washers, backing plates, collars, nuts, threaded inserts, clips, rivets, or adhesive layers can be incorporated on one or both sides of the host-object wall to distribute load or improve durability. A retrofit kit can include a template, hole saw dimensions, a drill guide, a reinforcement ring, a backing washer, and instructions that help a manufacturer or end user add the receiving opening in a controlled location.

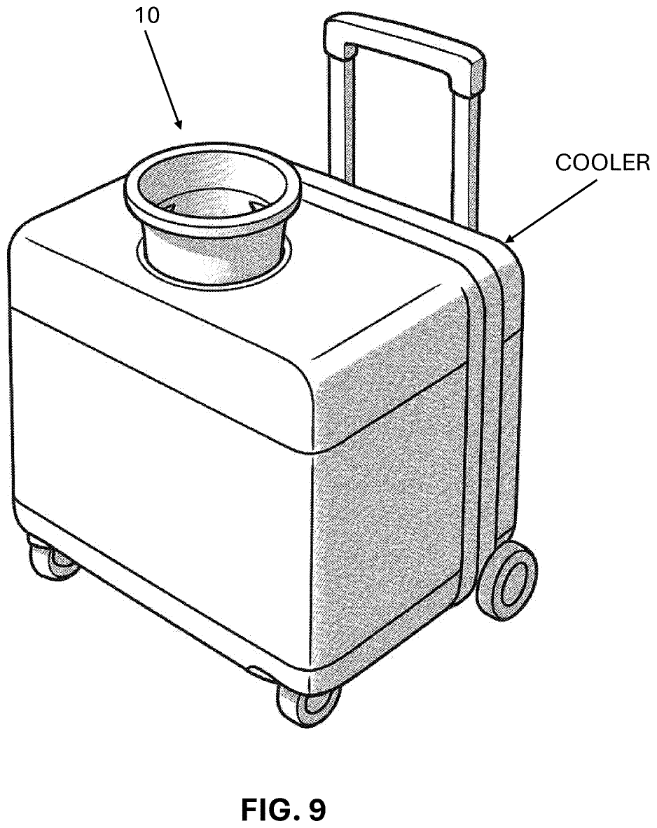

The concepts disclosed herein are equally applicable to host objects other than luggage. FIG. 9 illustrates a cooler implementation in which the insert 10 is mounted in a lid or upper wall of a cooler. In this environment, the insert can be configured to withstand moisture, temperature cycling, UV exposure, rough handling, cleaning agents, and impact. The coupling assembly may be selected so that the insert can be removed for cleaning or winter storage, or alternatively so that it remains semi-permanently mounted. In some cooler embodiments, the insert can include a drain arrangement that directs liquid away from insulated portions of the cooler lid. In other outdoor or recreational embodiments, the host object can be a portable table, boat surface, kayak accessory panel, paddleboard deck fixture, golf cart, lawn chair, tackle station, beach cart, or campsite structure. The insert may be configured to receive not only standard beverage containers but also insulated bottles or containers used in outdoor settings, and the selected materials may be chosen for corrosion resistance, UV resistance, and ease of rinsing.

FIG. 16 shows the insert mounted in a chair or similar furniture-related host object. The same general approach can be employed in folding chairs, stadium seating, recliners, waiting-room furniture, bedside furniture, service tables, tray arms, bench seating, and modular hospitality fixtures. The receiving opening can be formed in a seat surface, armrest, side panel, tray, console, or accessory board. In some furniture embodiments, a flush or nearly flush rim may be preferred for visual integration, while in other embodiments a raised rim can provide a more pronounced finished edge and greater resistance to side loading. Furniture-based embodiments may prioritize appearance, upholstery compatibility, cleanability, and resistance to beverages being jostled by occupant movement. In some institutional or hospitality embodiments, the insert can be designed so that it can be quickly removed and replaced for sanitation or maintenance, or so that branded rings, color-coded inserts, or promotional trim can be changed without replacing the surrounding furniture.

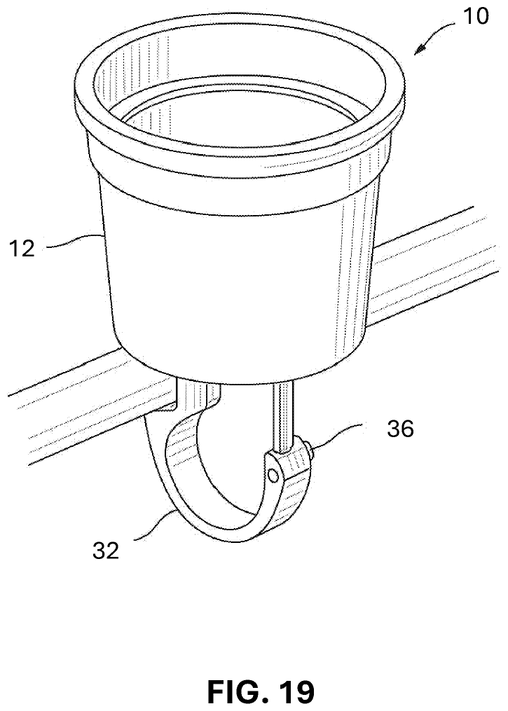

FIGS. 14 and 19 illustrate embodiments in which the insert is supported by a mounting dock 32 rather than by direct receipt in a host-object opening. In FIG. 14, the host object is a stroller or similar framed article. The mounting dock 32 can wrap around, clip to, clamp to, or otherwise engage a tubular or non-tubular frame member. In FIG. 19, a clamp assembly and lock 36 are shown in relation to a railing or frame member. The clamp can be configured to close around cylindrical, oval, square, rectangular, or irregular members, and the lock 36 can be a screw lock, cam lock, snap lock, latch, threaded fastener, detent, spring-biased pawl, over-center mechanism, or other device that maintains the clamp in a desired closed state. The dock can be fixed relative to the insert or can provide one or more degrees of freedom, such as swiveling, tilting, pivoting, ratcheting, or ball-joint articulation. This can help maintain the receptacle in a more upright orientation when the host object is inclined, when the frame member is not horizontal, or when the user wants to selectively orient the insert for convenience. Clamp-mounted embodiments are useful on strollers, carts, walkers, wheelchairs, exercise equipment, marine railings, hand trucks, ladders, folding bleachers, beach wagons, and other structures that may not present a dedicated aperture for an insert.

Where a mounting dock 32 is employed, the dock itself can take numerous forms and can be configured as a permanent or removable intermediary between the insert and the host object. A dock may comprise a clamp body, a socket, a cup-shaped cradle, a ring support, an articulating arm, a rail slide, a webbing mount, a hook interface, or a docking rail. The insert can be removably snapped into the dock, threaded into the dock, captured by a bayonet interface, or retained by a latch so that the same dock remains on the host object while the receptacle portion is removed for cleaning, storage, or transfer to another location. In some embodiments, the dock can include interchangeable inserts or bushings to fit frame members of different diameters. In still other embodiments, the dock can include resilient liners, anti-slip pads, or protective sleeves that reduce damage to the host-object surface. A dock may also include a deliberate breakaway feature that releases under a threshold load to reduce the likelihood of injury or structural damage if the mounted insert is struck.

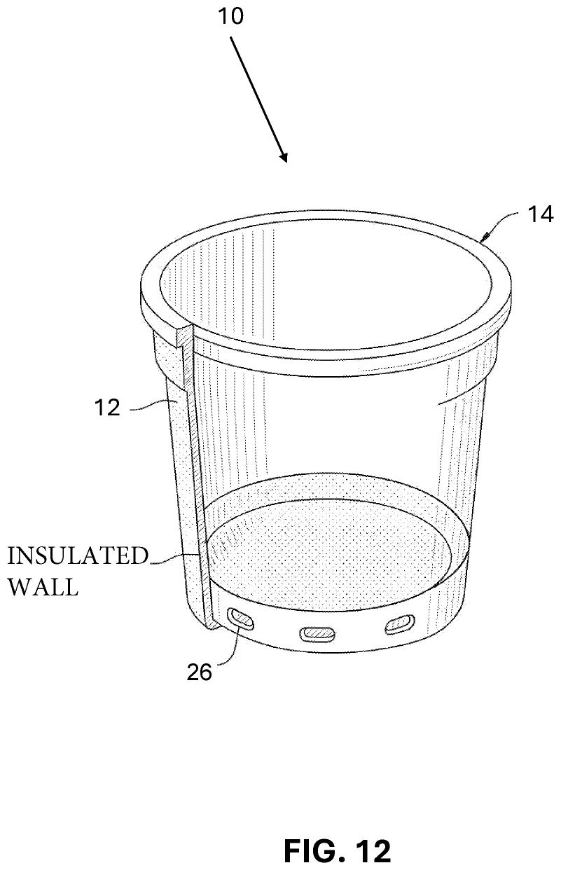

FIG. 12 illustrates an insulated embodiment having an insulated wall and one or more drainage openings 26. Thermal management can be achieved in many ways. The housing can have a double-wall configuration with an air gap, a foam-filled annular cavity, a vacuum-insulated section, a removable insulating sleeve, a phase-change material layer, a reflective barrier, or a thermally isolating liner. Insulation can be provided around the sidewall only, around the bottom wall only, or around both. Thermal-management structures can be selected to reduce warming of a cold beverage, reduce heat transfer from a hot beverage to the host object, reduce condensation, or improve user comfort when touching the insert. Drainage openings 26 can be located in the bottom wall, in a lower sidewall region as shown, at the interface between components, or in a removable drain tray. The openings may be permanently open, selectively closable by plugs or valves, covered by screens, or shaped to reduce debris ingress. In some embodiments, drainage is omitted entirely to contain spills. In other embodiments, the insert can be configured with a removable cup or liner that can be emptied independently of the surrounding mount.

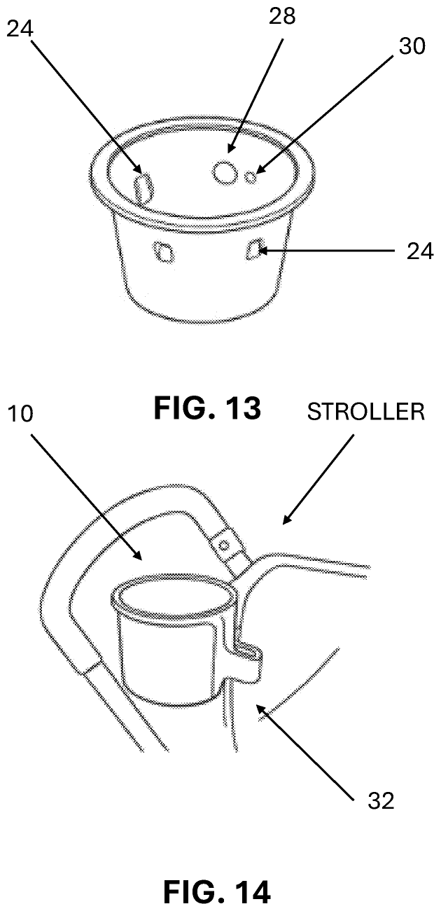

FIG. 13 illustrates optional smart-enabled or electronically enhanced embodiments. A light source 28 can be located in the rim, sidewall, bottom wall, or another portion of the insert. The light source can illuminate the receptacle interior, provide decorative accent lighting, indicate temperature conditions, indicate presence or absence of a container, show battery or charging status, or signal that the insert is properly locked to the host object. A sensor 30 can detect motion, tilt, vibration, temperature, moisture, the presence of a container, proximity to a user device, or the state of a latch or lock. The insert can include a local battery, a wired power connection, inductive charging, or an interface to a host-object power source. Electronic embodiments can include a heater, a cooling device, a charger, a wireless tag, an NFC element, a Bluetooth or other radio beacon, a speaker, a haptic alert feature, or a memory device. In certain applications, a sensor can detect when a beverage container has been removed and can prompt an alert to reduce the likelihood that the user forgets the beverage. Electronics can be sealed, removable, modular, or entirely absent. The structural features of the insert remain useful whether or not any electronics are present.

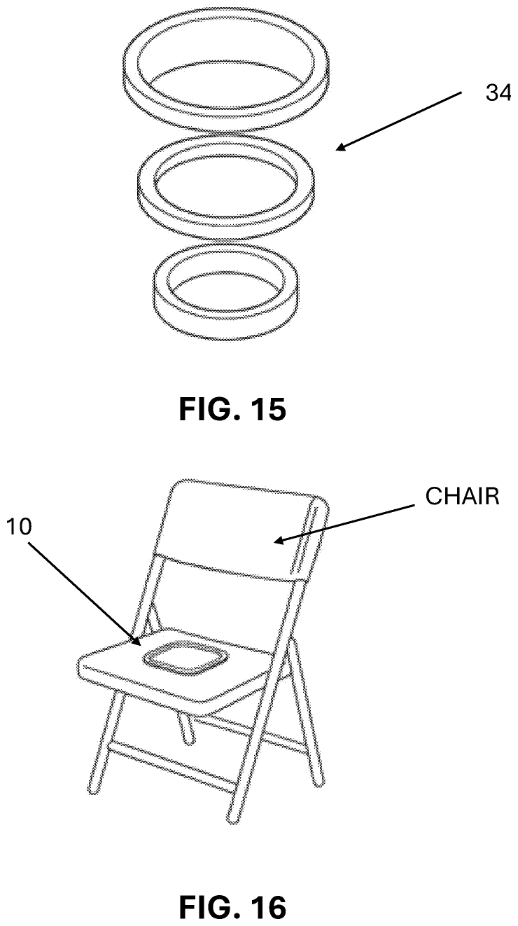

FIG. 15 illustrates interchangeable rings 34, but the disclosure contemplates a broad family of interchangeable internal accessories. A ring can reduce the effective diameter of the receptacle, add friction, cushion a container, or provide a decorative or branded appearance. Rings may be rigid, resilient, split, hinged, threaded, snap-fit, magnetically retained, or friction retained. Different rings may correspond to different container classes, such as standard cans, bottled beverages, travel tumblers, or narrow disposable cups. In some embodiments, a ring can include an inward lip or shoulder that supports a container at a selected height. In other embodiments, a ring can include a cutout for a mug handle, a straw slot, a spill lip, or a lid-retention interface. Accessories need not be limited to rings. The insert may additionally or alternatively receive sleeves, liners, bumpers, bottom inserts, anti-rattle pads, trays, drip cups, filters, covers, caps, and lids. A modular kit may therefore allow the user to adapt the same base insert body to different beverage sizes, environments, or aesthetic themes.

In some embodiments, the insert can be collapsible, telescoping, or otherwise movable between a use configuration and a reduced-profile storage configuration. Although a collapsible arrangement is not required in the embodiments depicted in the drawings, the present disclosure contemplates nested telescoping wall sections, accordion-style sidewalls, living-hinge folds, segmented panels, rollable sleeves, or removable extension rings that can change the effective height or volume of the receptacle. A collapsible insert may be advantageous where the host object is used in travel or space-constrained settings and the user desires a lower profile when the beverage holder is not needed. A telescoping or collapsible insert can cooperate with the same types of coupling assemblies described above. In some constructions, the insert can remain mounted to the host object while only the receptacle portion collapses. In others, the insert can be detached and nested within itself or within a storage pocket. Biasing structures, detents, stops, friction surfaces, and latches can be used to maintain the selected configuration.

The exterior of the insert can include functional and aesthetic features beyond those strictly necessary to hold a beverage container. The outer surface of the housing can include texturing, grooves, ribs, logos, decorative bands, transparent or translucent windows, color-changing materials, wear-resistant coatings, or labels. A designer or manufacturer may coordinate the insert with a particular luggage line, furniture collection, sports team, brand, event, or hospitality environment. The insert can be sold as an aftermarket accessory, as an original-equipment part integrated into a host object, or as part of a kit that includes multiple docks or adapters. In some embodiments, the insert can include accessory features such as a hook for keys, a tether point, a small tray, a phone-rest feature, a coaster surface, or a spill barrier extending above the rim. Any such accessory can be permanent, removable, or integrated into a ring or dock rather than the primary housing body.

Dimensional customization can also be used to broaden applicability. The insert may be produced in standardized size families, such as small, medium, and large, or may be customized for a particular brand of luggage, stroller, or furniture. The depth of the receptacle, diameter at the rim, lower diameter, wall angle, height of retention members, and location of the coupling assembly can all be adjusted independently. In some embodiments, a manufacturer may provide a universal outer insert body together with different internal adapters and different coupling kits. In other embodiments, the insert may be custom-formed or additively manufactured for a particular niche host object or beverage-container class. The insert can also be configured to nest with similarly sized inserts for shipment or retail display. Thus, both standardized mass-market versions and specialized custom-fit versions are contemplated within the same overall disclosure.

Design parameters for the insert can be selected based on expected loading and environmental exposure. A travel-oriented insert may prioritize low mass, compactness, and impact resistance. A furniture-oriented insert may prioritize aesthetics, quiet operation, and cleanability. A marine or outdoor insert may prioritize drainage, corrosion resistance, UV resistance, and secure retention under vibration or movement. In some embodiments, the insert can be designed to withstand repeated insertion and removal cycles, drop events, clamp cycles, thermal cycling, beverage spills, cleaning chemicals, and exposure to sunlight. Reinforcing ribs, thicker rim sections, compliant damping layers, or sacrificial wear surfaces can be incorporated where durability is emphasized. Where softer host-object materials such as fabric, foam, or upholstered panels are involved, the insert can include wider load-distribution surfaces, backing plates, or larger contact pads to reduce localized stress. These considerations further demonstrate that the same inventive concept can be scaled and tuned for many different product categories.

Although many examples herein focus on a single receptacle, the disclosed concepts can also be implemented in multiple-receptacle or grouped-accessory arrangements. A host object can include two or more receiving features positioned side by side, fore and aft, or on opposite sides of the host object. A common mounting plate or dock can support multiple cupholder inserts, or a single body can define multiple receptacle regions of different sizes. One receptacle region may be optimized for a beverage while another supports a phone, snack, bottle cap, utensils, or other article. Likewise, a modular accessory platform can support one or more cupholder inserts together with trays, organizers, hooks, or storage bins. These clustered arrangements can be particularly useful on luggage, carts, strollers, service trolleys, beach wagons, and hospitality furniture where users often manage several items simultaneously. The claims should therefore not be construed as limited to only one receptacle per installed assembly unless such a limitation is expressly recited.

Security and anti-loss features may also be incorporated, especially in shared or public-use environments. A cupholder insert can include a tether point for connection to the host object, a retention cable, a breakaway safety tether, a keyed anti-removal structure, or an identifier such as a serial number, barcode, QR code, NFC tag, or radio-frequency element. In fleet, hospitality, childcare, healthcare, rental, or commercial baggage applications, these features can facilitate inventory control, asset tracking, maintenance logging, or user association. An electronic embodiment can record usage information, detect when the insert has been removed from a host object, or communicate a status to a user device or host-object system. Even without electronics, visual identification can be provided by color coding, branding, engraved markings, or replaceable nameplates. These variations do not alter the basic receptacle-and-coupling concept but can make the insert more suitable for institutional or multi-user settings.

Additional container-management features may be incorporated where spill reduction or containment is important. For example, the upper region of the receptacle can include an inward lip, splash guard, partial cover, flexible diaphragm, or removable lid that reduces slosh when the host object is moving. A lid or guard can include a center opening sized for a straw or bottle neck, a hinged door, a resilient membrane, or segmented petals that flex around an inserted container. The insert can further include overflow channels, spill reservoirs, absorbent pads, removable coasters, or moisture-wicking elements. In some embodiments, the rim or an accessory ring can be shaped to cooperate with a conventional disposable-cup lid or a reusable tumbler lid to improve stability. In other embodiments, the insert can include a secondary retention strap, flexible tether, or top-mounted clasp for securing unusually tall or top-heavy containers. These features can be used individually or in combination with the sidewall retention structures and lower support structures described elsewhere herein.

The insert can be configured for permanent integration, semi-permanent integration, or quick removability. In a permanent or near-permanent arrangement, the insert or a docking structure can be riveted, bonded, welded, molded-in, or otherwise assembled into the host object so that removal is not expected during normal use. In a semi-permanent arrangement, the insert can be removed with a tool or by intentionally releasing a latch, threaded engagement, or retaining clip. In a quick-removal arrangement, the insert can be lifted, twisted, unclamped, unsnapped, or otherwise detached by hand so that the user can transfer it among different host objects, wash it separately, or store it when not needed. Some embodiments can provide a lockable removal condition in which the insert remains detachable only after actuation of a keyed lock, tool-requiring feature, hidden release, or over-center retainer. The same underlying receptacle body may therefore be adapted to different commercial preferences concerning theft deterrence, user convenience, serviceability, and long-term durability.

The manner in which the host object presents a receiving feature can vary widely and can be tailored to the materials and construction of the host object. A receiving feature may be a simple circular through-hole, but it can also be a blind recess, a pocket with a narrowed mouth, a slotted opening, a keyed opening, an undercut groove, a grommeted fabric opening, a molded receiver, a bracket, a webbing loop, a MOLLE-compatible interface, a track, a rail, or a dedicated accessory port. In some embodiments, the host object can define a bezel, trim ring, escutcheon, or replaceable receiver insert through which the cupholder insert is mounted. In other embodiments, the host object can provide only a generally flat or curved mounting surface, and the coupling assembly can be selected to cooperate directly with that surface through magnets, adhesives, suction, clamps, straps, or other structures. A receiving feature therefore can be purpose-built for the insert, modified in the field to receive the insert, or can be an already existing structural feature of the host object that happens to be suitable for cooperation with the selected coupling assembly.

The host object itself can take many forms and is not limited to the representative examples expressly shown. The host object can be portable or stationary, rigid or flexible, consumer-oriented or commercial, personal or shared, indoor or outdoor, and designed for travel, work, recreation, healthcare, transportation, hospitality, or household use. By way of non-limiting example, the host object can be a suitcase, hard-shell case, soft-sided luggage article, trunk organizer, pet carrier, stroller, wheelchair, walker, utility cart, shopping cart, cooler, folding chair, stadium seat, hospital chair, bedside rail, bed tray, wheelchair tray, exercise machine, lawn-equipment handle, ladder rail, boat console, marine railing, vehicle console, seatback accessory, aircraft cabin component, train or bus seating component, golf cart, beach cart, service trolley, warehouse cart, workstation fixture, or another structure for which accessible support of a beverage container may be desirable. The receiving feature can be located on an upper surface, lower surface, side surface, angled surface, frame member, handle region, pocket region, tray, shelf, or dedicated mount. The insert can therefore be oriented in many ways, provided that the receptacle is maintained in a functional configuration through direct geometry, dock articulation, or other support structure.

The cupholder insert can be supplied as a standalone article, as part of a retrofit kit, or as part of an integrated host-object assembly. A retrofit kit can include the insert, one or more interchangeable rings or sleeves, one or more coupling assemblies, a mounting dock, a clamp, a reinforcement plate, a drilling or cutting template, fasteners, instructions, and optional decorative elements. An original-equipment assembly can incorporate a preformed opening, a captured nut or threaded insert, a molded receiver, an internal reinforcement, or a concealed magnetically attractive structure designed specifically for the insert. The same insert may be used across a family of products, with the host objects differing primarily in the mounting features provided. In some commercial arrangements, the insert can be licensed or co-branded for use by luggage manufacturers, stroller manufacturers, furniture makers, or hospitality providers. In some embodiments, consumable or replaceable liner elements can be sold separately so that a worn or contaminated inner surface can be refreshed without replacing the entire insert or dock.

Installation and use can vary according to the selected coupling architecture. In one example, the user aligns a bottom-mounted deformable fastener with an opening in the host object, presses the insert downward until the retaining portion passes through the opening, and allows the fastener to expand into a retained condition. In another example, the user threads the insert or a threaded mounting element into a receiving feature of the host object. In a clamp-based example, the user positions the dock around a frame member, closes the clamp, tightens or actuates the lock 36, and then places the insert into or onto the dock. In a magnetic example, the insert is simply brought adjacent a magnetically attractive region of the host object and is retained by magnetic force. In each case, a beverage container can then be placed into the receptacle. The container may engage the sidewall directly, engage one or more retention members 24, or engage a selected accessory such as an interchangeable ring 34 or sleeve. Where drainage openings 26 are provided, any spilled liquid or condensation can be permitted to drain. Where a removable liner or tray is provided, the user can empty and clean that component separately.

The disclosed structures can be configured to improve stability during motion and real-world use. The shape of the receptacle, the height and stiffness of the sidewall, the location and characteristics of the retention members, the nature of the bottom support, and the manner in which the insert is coupled to the host object can all be selected to reduce slosh, rocking, rattling, or accidental dislodgement. In dynamic applications such as rolling luggage, strollers, walkers, wheelchairs, and carts, the insert can be positioned so that the beverage container remains accessible while minimizing interference with handles, wheels, zippers, user movement, or folding mechanisms. A swivel or tilt-capable dock can help maintain the receptacle closer to vertical even if the host-object attachment point is angled. Anti-rotation structures, vibration-damping elements, resilient liners, and distributed load paths can further improve performance over uneven surfaces. These concepts can be implemented singly or in combination depending on the expected environment.

Cleaning, sanitation, and serviceability can be important in many applications, and the present disclosure readily accommodates such considerations. Smooth interior surfaces can be used where easy wipe-down is preferred, while removable liners, sleeves, trays, or inserts can be used where thorough washing is desired. Materials can be selected to resist staining from coffee, juice, soda, or sports drinks. Some embodiments can be dishwasher-safe, while others can be hand-washed or wiped with sanitizing agents. Electronics, if present, can be sealed to an appropriate ingress-protection level or can be housed in removable modules. A modular insert can therefore be adapted to consumer travel applications, childcare applications, healthcare settings, hospitality environments, and outdoor-use contexts without departing from the broader inventive concepts disclosed herein.

Although many of the drawings depict the insert as a generally self-contained receptacle body with a single central coupling feature, it should be understood that the claims are intended to encompass structures having one, two, or more receptacle regions, one or more support arms, one or more coupling points, and one or more interchangeable accessories. Likewise, a feature described in connection with one embodiment can be combined with a feature described in connection with another embodiment unless such combination would be physically incompatible. For example, an insulated receptacle can also include resilient retention members, a modular ring system, a clamp-mounted dock, and electronic sensing features. A luggage-mounted embodiment can employ the same internal liner or ring technology as a stroller-mounted embodiment. A cooler-mounted embodiment can employ the same deformable fastener or threaded interface as a furniture-mounted embodiment. The drawings are therefore exemplary and are not intended to portray every possible combination.

It should also be understood that relative terms such as upper, lower, top, bottom, inward, outward, inner, outer, above, below, front, rear, left, right, central, and peripheral are used for ease of description with reference to the orientations shown in the drawings or encountered in ordinary use. Such terms are not intended to require any absolute orientation during manufacture, packaging, transport, storage, or operation. Similarly, dimensional relationships, material selections, and mounting techniques can be scaled or adapted to suit different host objects and different beverage-container classes. Accordingly, the disclosed cupholder insert 10, the associated host-object assemblies, and the disclosed installation and use methods should be understood as embracing all modifications, equivalents, substitutions, and combinations falling within the spirit and scope of the present disclosure as defined by the claims and their legally applicable equivalents.

1. A cupholder insert configured to be removably coupled to a host object, the cupholder insert comprising:
a housing defining an interior receptacle sized to receive a beverage container, the housing including an upper rim and a bottom wall opposite the upper rim; and
a coupling assembly carried by the housing and configured to engage a receiving feature of the host object to retain the cupholder insert relative to the host object.

2. The cupholder insert of claim 1, wherein the housing tapers from a larger cross-sectional dimension adjacent the upper rim to a smaller cross-sectional dimension adjacent the bottom wall.

3. The cupholder insert of claim 1, wherein the upper rim includes an outward flange configured to overlie an exterior surface of the host object.

4. The cupholder insert of claim 1, wherein the interior receptacle includes a plurality of resilient retention members extending inwardly to engage beverage containers of different sizes.

5. The cupholder insert of claim 1, wherein the coupling assembly comprises a deformable shaft and an enlarged head configured to pass through an opening in the host object and resist withdrawal from the opening.

6. The cupholder insert of claim 1, wherein the coupling assembly comprises at least one of a threaded mount, a magnetic mount, a suction mount, a snap-fit mount, a friction-fit mount, a strap assembly, or a clamp assembly.

7. The cupholder insert of claim 1, wherein the housing is movable between an expanded use position and a collapsed storage position by telescoping sections, hinged sidewalls, or an accordion wall structure.

8. A beverage-holder assembly comprising:
a host object having at least one of an opening and a mounting structure; and
the cupholder insert of claim 1 coupled to the host object by engagement of the coupling assembly with the at least one of the opening and the mounting structure.

9. The beverage-holder assembly of claim 8, wherein the host object comprises luggage.

10. The beverage-holder assembly of claim 8, wherein the host object comprises a cooler, a chair, a stroller, a cart, a wheelchair, a walker, camping equipment, or a vehicle interior component.

11. The beverage-holder assembly of claim 8, wherein the cupholder insert is detachably received in an opening of the host object such that the upper rim limits movement of the cupholder insert through the opening.

12. The beverage-holder assembly of claim 8, further comprising a mounting dock coupled between the cupholder insert and the host object, the mounting dock being configured to tilt or swivel to maintain the cupholder insert in a more upright orientation during use.

13. The beverage-holder assembly of claim 8, wherein the coupling assembly includes a clamp configured to secure the cupholder insert to a rail, handle, or frame member of the host object.

14. The beverage-holder assembly of claim 8, further comprising one or more interchangeable rings selectively positionable within the interior receptacle to adapt the cupholder insert to beverage containers of different sizes.

15. A method of providing a beverage holder to a host object, the method comprising:
positioning a cupholder insert adjacent a receiving portion of the host object, the cupholder insert having a housing defining a beverage-receiving interior, an upper rim, a bottom wall, and a coupling assembly carried by the housing;
engaging the coupling assembly with the receiving portion of the host object to secure the cupholder insert relative to the host object; and
placing a beverage container in the beverage-receiving interior.

16. The method of claim 15, wherein engaging the coupling assembly comprises inserting a deformable fastener through an opening in the host object.

17. The method of claim 15, wherein engaging the coupling assembly comprises clamping the cupholder insert to a rail, handle, or frame member of the host object.

18. The method of claim 15, further comprising selecting an interchangeable ring and placing the interchangeable ring within the beverage-receiving interior to adapt the cupholder insert to a selected beverage-container size.

19. The method of claim 15, wherein placing the beverage container in the beverage-receiving interior causes one or more resilient retention members to flex into engagement with the beverage container.

20. The method of claim 15, further comprising permitting liquid to pass through one or more drainage openings formed in a lower portion of the cupholder insert.
